(19) United States
(12) Patent Application Publication
(10) Pub. No.: US 2018/0040014 A1
(43) Pub. Date: Feb. 8, 2018

(54) SYSTEM AND METHOD INCORPORATING DISCOUNT BASED INCENTIVES IN A MULTI-LEVEL CONSUMER ENVIRONMENT

(71) Applicant: Romain COLLOMBY, Bangkok (TH)

(72) Inventor: Romain COLLOMBY, Bangkok (TH)

(21) Appl. No.: 15/230,777

(22) Filed: Aug. 8, 2016

(51) Int. Cl. G06Q 30/02

(52) U.S. Cl. CPC G06Q 30/0233; G06Q 30/0232; G06Q 30/0229

(57) ABSTRACT

A system determines points within a hierarchical marketing environment across several different business entities. The points are collected based on activities within the business entities. Three different categories of points are determined, with the difference in points being where the activities occur and whether points are redeemed for a discount or reward. A central server connects to a network of devices to redeem and collect points.

### FIELD OF THE INVENTION

The present invention relates to the incorporation of discount based incentives in a multi-level or affiliate marketing environment. More specifically, the present invention relates to a discount based incentive system and platform that operates across different business entities.

### DESCRIPTION OF THE RELATED ART

Numerous marketing schemes exist that reward consumers for their behavior. A common organization is a hierarchy structure, such as multi-level marketing (MLM). MLM organizations typically have a person that purchases products directly from a manufacturer and then sells these products to consumers, much like a normal business. Another aspect of MLM organizations is that the person also may encourage others to sign up with the manufacturer to market the products. The people signed up under this process may be called “downline” while the person is an “upline.” The person does not serve in a supervisory role usually associated with normal business practices. The upline, however, receives compensation based on the activities of the downline.

Other marketing plans include referral programs, where a consumer receives benefits from encouraging others to sign up with a business. As the signees shop at the business, the consumer receives coupons or discounts. The consumer, however, does not receive direct compensation from the business.

### SUMMARY OF THE INVENTION

The disclosed embodiments include a system to incorporate rewards or discount based incentives across several entities. The rewards or discounts derive from points collected on purchases and activities linked in a hierarchy structure.

A computer-implemented method for using discount based incentives in a marketing environment having a plurality of business entities connected by a network is disclosed. The plurality of business entities include member linked in a hierarchical structure. The computer-implemented method includes accumulating a first type of points based on activity within a first business entity by a member and at least one downline member associated with the member within the first business entity as well as on activity within a second business entity by the member and at least one downline member associated with the member within the second business entity. The computer-implemented method also includes accumulating a second type of points based on activity within the first business entity by the member and at least one downline member associated with the member within the first business entity. The computer-implemented method also includes storing the first type of points and the second type of points in a database connected to the first and second business entities. The computer-implemented method also includes accessing a client input page on a device connected to the network by the member to make a purchase at the first business entity. The computer-implemented method also includes retrieving an amount of the first type of points and an amount of the second type of points from the database in response to accessing the client input page. The computer-implemented method also includes redeeming an amount of the first type of points and an amount of the second type of points according to the first business entity. The computer-implemented method also includes applying a discount to the purchase by the member based on the amount of the first type of points and the amount for the second type of points at the first business entity.

A computer-implemented method for applying a discount within a marketing environment having a plurality of business entities associated with each other over a network connected to a central server is disclosed. The plurality of business entities include members linked in a hierarchical structure. The computer-implemented method includes accessing a page on a device connected to the network to make a purchase at a first business entity. The computer-implemented method also includes retrieving, from the central server, a first type of points for a member of the plurality of business entities. The first type of points is related to the first business entity and a second business entity that is separate from the first business entity. The computer-implemented method also includes retrieving, from the central server, a second type of points for the member. The second type of points is related to the first business entity. The computer-implemented method also includes determining whether to redeem the first type of points and the second type of points in conjunction with making the purchase at the first business entity. The computer-implemented method also includes applying a discount based on the redemption of the first type of points and the second type of points to the purchase.

A computer network system also is disclosed. The computer network system includes a plurality of business entities connected over a network to a central server. Each of the plurality of business entities includes a hierarchical member structure such that members within each of the business entities are linked together. The computer network system also includes a central server having a database to store information about each of the plurality of business entities. The computer network system also includes a communication device at the central server to exchange data between the central server and a plurality of devices associated with each member with each of the business entities. The computer network also includes a calculation device at the central server to determine a discount for a purchase within a first business entity based on a second type of points accumulated from activity of a member and at least one downline member with the first business entity and further based on a first type of points accumulated from activity of the member and at least one downline member with the first business entity and from activity of the member and the at least one downline member with a second business entity separate from the first business entity.

### BRIEF DESCRIPTION OF THE DRAWINGS

Various other features and attendant advantages of the present invention will be more fully appreciated when considered in conjunction with the accompanying drawings.

FIG. 1 illustrates a communication network for incorporating rewards in a hierarchy structure commerce environment according to the disclosed embodiments.

FIG. 2 illustrates a block diagram of a mobile device according to the disclosed embodiments.

FIG. 3 illustrates a block diagram of example business entities according to the disclosed embodiments.

FIG. 4 illustrates a block diagram of a web platform for use with the system according to the disclosed embodiments.

FIG. 5A illustrates a flowchart for registering a client profile for incorporating rewards in a hierarchy structure commerce environment according to the disclosed embodiments.

FIG. 5B illustrates a flowchart for creating a member profile according to the disclosed embodiments.

FIG. 6 illustrates a flowchart for making a purchase within the system using accumulated points according to the disclosed embodiments.

FIG. 7 illustrates a flowchart for calculating discounts and rewards for a purchase within the system according to the disclosed embodiments.

FIG. 8 illustrates a flowchart for accumulating point totals for a member within a business entity according to the disclosed embodiments.

FIG. 9A illustrates a flowchart for using points within the system according to the disclosed embodiments.

FIG. 9B further illustrates the flowchart of FIG. 9A.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

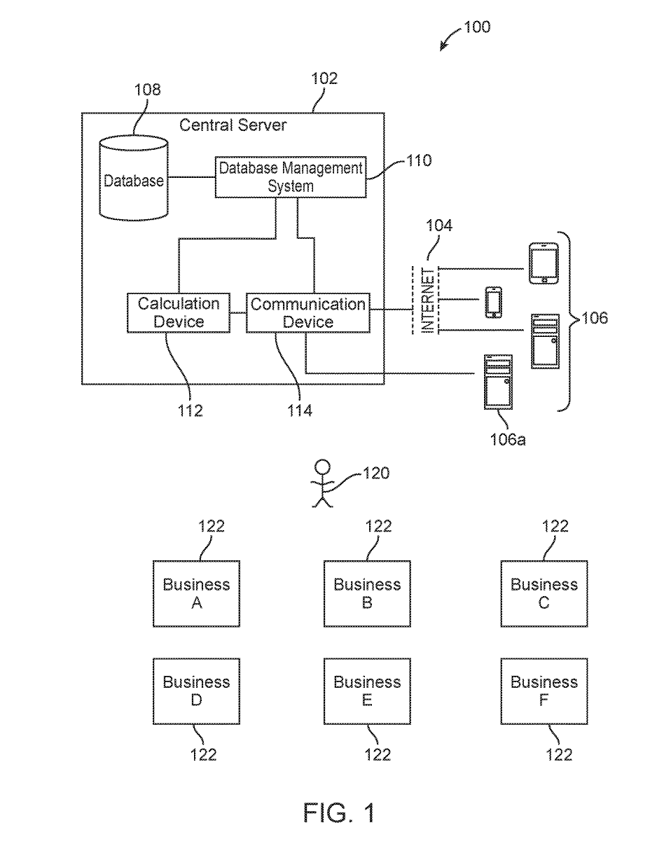

FIG. 1 depicts an example communication network 100 for incorporating rewards in a hierarchy structure commerce environment according to the disclosed embodiments. Various client devices may communicate with each other within environment 100, such as devices 106. Devices 106 include mobile telephones, smartphones, desktop computers, laptop computers, tablets, smart watches and televisions, point-of-sale devices, and the like. Devices 106 may exchange information with a central server 102 over information network platform 104. Preferably, network platform 104 is the Internet. Each device 106 may have an Internet protocol address to distinguish the different devices from each other.

Central server 102 also communicates with other components in network 100. Central server 102 may act as the control component of the disclosed embodiments in that the functions and process are executed at the server or under its direction. Central server 102 includes a database 108 to store information and data regarding the auxiliary marketing system. For example, records may be stored in database 108 for each participant and customer in the hierarchy structure as well as the relationship between all the participants. Database 108 also stores the points for each participant.

Central server 102 also includes database management system 110. Database management system 110 retrieves and stores information within database 108. For example, database management system 110 may retrieve records as request through central server 102. Further, database management system 110 receives updates or information to be stored in database 108 and determines the data structure to implement or modify in response. Database management system 110 may include a processor to execute operations as well as its own dedicated memory to store instructions for execution by the processor.

Calculation device 112 and communication device 114 also reside on central server 102. Calculation device 112 executes the processes to determine the amount of points or other values associates with participants in the marketing structure. Central server 102 receives data from devices 106 on activity of the participants across various business entities using communication device 114. Calculation device 112 then updates the points and any rewards associated as a result of the received data, as disclosed below.

Calculation device 112 also may include a processor to execute the operations to enable the processes disclosed below. It also may include a memory to store instructions for the processor as well as any data needed to implement its functions. Alternatively, calculation device 112 may be a software program that configures a processor into a special purpose processor dedicated to executing the functions disclosed below. Communication device 114 is hardware, firmware, or software that receives and transmits packets of information over network platform 104 to devices 106. Communication device 114 may modify the information to meet the different protocols supported by network platform 104.

Other components may be included in central server 102. Further, the central server may be a plurality of servers linked together to provide the resources needed to support the disclosed system. For example, central server 102 may access three databases 108, with two databases located in other servers. Database management system 110 coordinates interaction with the different databases to ensure that the proper information is stored in the proper location.

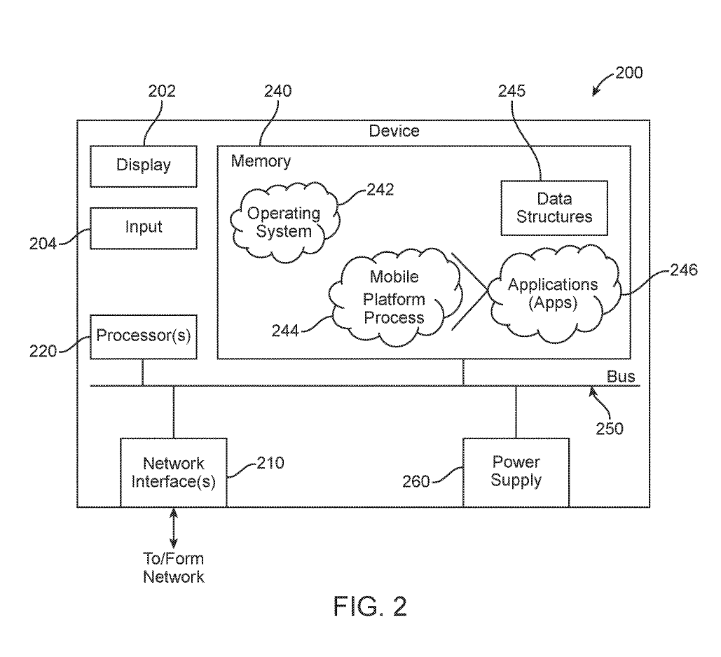

FIG. 2 depicts a block diagram of a mobile device 200 according to the disclosed embodiments. Mobile device 200 relates to a mobile device of devices 106 shown in FIG. 1. Other computers and devices also may incorporate some features of mobile device 200 in providing the functionality disclosed below. In short, the components shown in FIG. 2 may be found in any of devices 106.

Mobile device 200 includes one or more network interfaces 210, at least one processor 220, and a memory 240 interconnected by a system bus 250. Power supply 260 supplies power to device 200 as well as the components disclosed therein. Other components may be included in device 200, such as a display 202 and input module 204. Display 202 provides visual information to the user and shows the icons for different applications 246 stored on device 200. Input module 204 may include a graphical user interface (GUI), keyboard, mouse, and the like that allows the user to interact with device 200.

Network interface(s) 210 contain the mechanical, electrical, and signaling circuitry for communicating data over links coupled to network environment 100. Network interfaces 210 may be configured to transmit or receive data using a variety of different communication protocols. Further, device 200 may include two or more different types of connections for network interfaces 210, such as a wired/physical, wireless, or cellular, and the like. Network interfaces 210 also may be configured as a general image input device, such as a code scanner, image detector, and the like.

Memory 240 includes a plurality of storage locations that are addressable by processor 220 for storing software programs and data structures 245 associated with these programs. The software programs include applications that reside in memory 240 until launched by processor 220. Processor 220 includes hardware elements or hardware logic adapted to execute the software programs and manipulate data structures 245.

An operating system 242, which resides in memory 240 and is executed by processor 220, functionally organizes device 200. These software processes or services may comprise a mobile platform process 244, in addition to one or more applications, or apps, 246. Applications 246 may each be configured depending upon the particular device 200 within network environment 100.

Other processor and memory types, including various computer-readable media, may be used to store and execute program instructions pertaining to the techniques described herein. While the disclosed embodiments illustrate various processes, it is expressly contemplated that various processes may be embodied as modules configured to operate in accordance with the functions disclosed below. While the processes have been shown separately, those skilled in the art will appreciate that processes may be routines or modules within other processes.

Mobile platform process 244 and applications 246 may each contain computer executable instructions executed by processor 220 to perform various functions. For example, applications 246 may include one or more specific or integrated applications, such as a web browser to access and view content over network environment 100. Other specific applications 246 may include such feature specific applications such as music player apps, consumer product purchasing apps, travel apps, social media apps, banking or financial apps, messaging apps, and the like.

The functionality disclosed below may be performed by hardware, software, or firmware, such as in accordance with mobile platform process 244, which contains computer executable instructions executed by processor 220 to perform the functions corresponding to the apps.

On mobile device 200, the various applications 246 may be represented graphically by an icon. An icon is a pictogram displayed on a screen in order to help a user navigate a computer system. The icon is a quickly comprehensible symbol of an application 246. It can serve as an electronic hyperlink or file shortcut to access the application that it represents. The application is activated to turn mobile device 200, for example, from a computing platform to a specific purpose platform. The user activates the icon by using a mouse, pointer, finger, or even voice commands. The placement on display 202 in relation to other icons may be set according to some criteria or by the user. In activating an application using an icon, the user can move directly in and out of the identified application without knowing anything about the location or requirements of the data structures, or code.

Periodically, device 200 may receive instructions from central server 102 via network platform 104 to update applications 246. Further, application 246 may store data that is sent to central server 102 as part of the disclosed marketing environment and to operate the affiliated marketing rewards system.

Referring back to FIG. 1, a plurality of independent entities 122 is shown. The entities may represent physical or virtual businesses. For illustrative purposes, businesses A, B, and C are shown. Member 120 may interact with each business entity 122 and receives points based on these interactions.

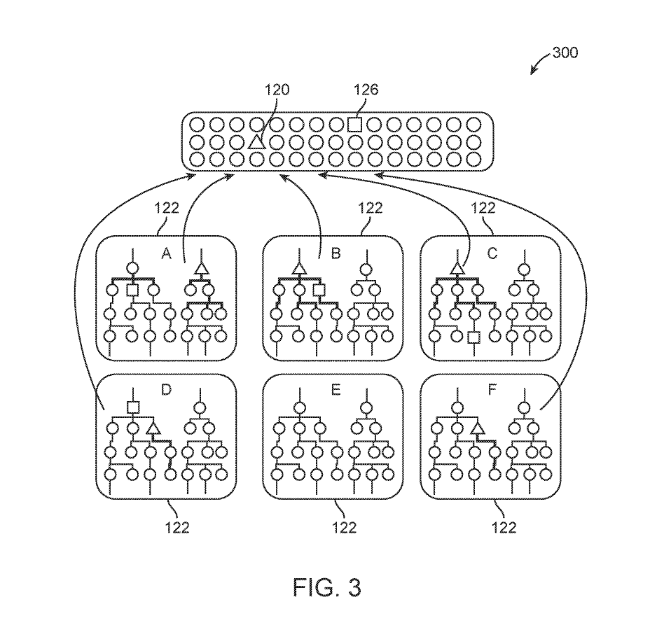

This concept may be shown in better detail in FIG. 3. FIG. 3 depicts a hierarchical business structure environment 300 according to the disclosed embodiments. Business entities 122 are shown with the structure for each. The basic structure is similar for each entity 122. In each entity, members 120 are organized by some methodology, such as genealogy, sponsorship, referrals, and the like. Preferably, the structures resemble a MLM structure. Each member can have up to 1 upline member directly linked to him/her. For example, in business entity B, member 120 is directly upline to member 126. In business entity D, member 126 is upline to member 120.

Moreover, each member can have a plurality of downline members directly linked. Referring to business entity A, member 120 has two direct downline members. The actual organization per entity may be different. For example, the maximum number of direct downline members may be different between entities. Thus, member 120 has two direct downline members in business entity A, but three in business entity B.

Within these entities, members 120 and 126 accumulate points due to activities taken within the business entities. There may be three categories of points. A first category is points X generated at cross entities. These points may be used on purchases. The other two types of categories of points are entity specific. These are points generated within the entity itself. A second category of points Y is used for discounts on purchases within the entity. A third category of points Z is used as an exchange for gifts, vouchers, or other rewards, within the entity.

Points are generated and collected from the activity of the member and from the activity of downline members linked directly or indirectly to the member. In the case of cross entity points, these points are collected from all entities where the member is listed. For entity specific points, the points are collected specifically from this entity. Thus, being a member within the disclosed system entitles one to two levels of discounts due to activities within the business entities.

Thus, for each entity participating in the disclosed process, each member is entitled to several types of benefits from converting points accumulated within the business entities. As noted above, three main types of points may be used. For convenience, the points are referred to as points X, points Y, and points Z. “Points” also may be referred to as types or categories, such as points of type X or points in category Z. For each type of points, the amount of points is calculated on the actual purchase amount, or the purchase value after any applicable discounts, by the member or the downline members linked to the member, either directly or indirectly, as shown in a hierarchical marketing organization.

Points Y, or points of type Y, are collected based on the level of a member's activity at one single entity. Points Y, in addition, may be used only at this entity. Type Y points may be exchanged for discounts on goods or services at the entity. Consequently, these points are used exclusively when making a purchase. This usage does not require any additional action from the member. On a particular case, a member may request to convert other points to type Y points, if the entity's policy allows for such a conversion. The conversion would occur according to the conversion rate set forth in the policy.

Points Z, or points of type Z, are collected based on the level of downline member's activities at one single entity. Type Z points also may only be used at the entity. Type Z points may be exchanged for free goods or services, such as in exchange for a voucher, cash, and the like at the entity. Thus, points Z are not bound by performing a purchase but require the member to make the explicit request to make the exchange by redeeming type Z points. The policy of the business entity may require the member, or customer, to perform a purchase before granting the requested good or service. On a particular case, a member also may request the conversion of type Z points to type Y points, if allowed by the policy and at a rate determined by the policy.

Points X, or points of type X, are collected based on the level of downline member's activities at a plurality of business entities 122. Type X points may be exchanged for a discount on goods or services. Thus, these points are used when making a purchase by the member. This usage typically does not require any additional action taken by the member.

Point collection is done for each type of points and for each entity. The collected points may be a percentage of the actual consumption, or the price actually paid for the good or service, of all members listed in the business entity, of each level. Each entity, however, may enact different calculation rates per level and per type of points. These rates are set forth in each entity's policy. For example, one entity 122 may have a 3% rate for all members 4 levels downline of the member. The member may receive points corresponding 3% of the total prices on all purchases by downline members connected to the member. In another example, the percentage rate for a type of points may be 5% for directly linked members, 3% for directly linked of directly linked members (friends of friends), and 1% for directly linked of directly linked of directly linked members. Thus, many point collection schemes may be enacted, though there must be some relationship between members to earn points.

The policies within the entities may be updated to reflect changes. For example, during a special promotion period, the collection rate of type X points may be twice the normal rate from members directly linked to another member. In another example, entity 122 may decide to extend the range of type Y point collection from 3 levels to 4 levels.

Entity policies also may set forth conversion rates per type of points. For example, the conversion rate of type X points and type Z points may differ between entities. The disclosed embodiments, however, take into account the points earned for purchases at another entity, or points X. In order to ensure a fair distribution of type X points, it is recommended to set a unique rate of collection, as well as a unique rate of usage, for all entities defined in the plurality of entities 122 of each type X points.

Referring to FIG. 3, members 120 and 126 are shown. Member 120 collects points in business entities A, B, C, D, and F based on the member's activities in those entities. With regard to entity A, member 120 collects points Y and Z for purchases or activities within entity A. Points Y may be used for discounts within with entity A. Points Z may be used for rewards within entity A. Member 120 would not receive points Y or Z for member 126's activities as this member is not within the downline organization. Staying with entity A, the activities of member 120 in entity B also results in points X being awarded from the cross entity relationship.

Looking at entity B, however, member 120 would receive points Y for activities taken by member 126 because this member is in the downline. The same scenario may be seen for entity C. The situation reverses in entity D with member 120's activities generating points for member 126 as the upline. According to the disclosed embodiments, limits may be placed on the levels of downline able to generate points for the member. For example, member 120 may only receive points for activities of two downline levels.

Discounts by application of points may occur after a generic discount at purchase within the entity, regardless of point amount, and the prior consumption of points used as a discount. In other words, member 120 may receive a generic discount and a discount from the conversion of collected points. These discounts are calculated and deducted automatically from the original purchase amount, after confirmation to central server 102. The actual purchase price within the business entity will include the applied discount.

Thus, two types of points are used for automatic discounts. One type, points X, are generated by cross entities. The disclosed system automatically calculates the discounts at the time of purchase, and should not require member action. At each use, only part of the cross-entities points X may be used, as a percentage of the total points available, and limited to a maximum of the resulting discount. All, some, or none of the points may be used in conjunction with the purchase.

Discounts may even be applied for a member not listed in the business entity. Referring to FIG. 3, business entity E does not include member 120 or member 126. If member 120, however, purchases products from business entity E, then he/she may still receive discounts under the disclosed system. First, a generic discount based on membership within the system may be provided. This discount could be a percentage of the original purchase price. Then, a discount may apply given the cross entity points, or points X, much like within other business entities. The discount under this scenario, however, may be limited to the amount after the generic discount and to the allowed fraction of the available point amount and to the allowed maximum discount amount as a percentage of the original purchase amount.

For a member listed within the business entity, the discounts are applied in the following fashion. First, a generic discount is provided as a percentage of the original purchase price. Second, a discount is provided as a conversion of the entity-specific points for a discount, or the use of points Y. Then, a discount is applied as a conversion of the cross-entity points, or points X. The application of points Y may be subject to the condition of reaching or exceeding a minimum level of consumption cumulated during a given period. This minimum consumption level is referred to as the activation level. The activation level corresponds to the level needed every month, quarter, year and the like, for a member within the hierarchy marketing network to maintain his/her access to entity-specific points.

The discount using certain points is limited based on other point levels. Thus, the discount given for entity specific points Y is limited to the amount of the sum of the amount after the generic discount and the cumulated previous actual purchase value, which exceeds the activation level, as well as the amount after the generic discount itself, plus the available amount of entity specific points Y. This limitation may apply to whatever point determination comes first. In other words, there is a limitation on the amount of discount available to member 120.

The conversion of cross entity points X is limited to the application purchase value reduced by the discount plus the allowed fraction of the available amount of cross entity points X. The discount for cross entity points X also is limited so that the final total discount does not exceed a pre-defined maximum level, preferably as a percentage of the purchase value. Again, the maximum discount for a purchase is set, and the application of cross entity points X may not exceed this amount.

Thus, each member 120 or 126 enjoys two levels of a profile. A generic profile is used system-wide using minimum information. The generic profile, for the most part, stores cross entity points and enables behavior analysis through the plurality of business entities, such as the ones shown in FIGS. 1 and 3. A member also has an entity profile that is specific to each business entity. The entity profile is used mainly to store entity-specific points and to position the member in the hierarchy of that entity.

Each business entity 122 also may include its own profile. These profiles include the parameters of the multi-level structure, or hierarchy, which will impact the listed members. The profiles also may include the geographic location, such as global positioning system (GPS) coordinates. A virtual shop may not include GPS coordinates, or, for instance, may use a (0,0) coordinate. The entity profile also lists the type of product or service offered.

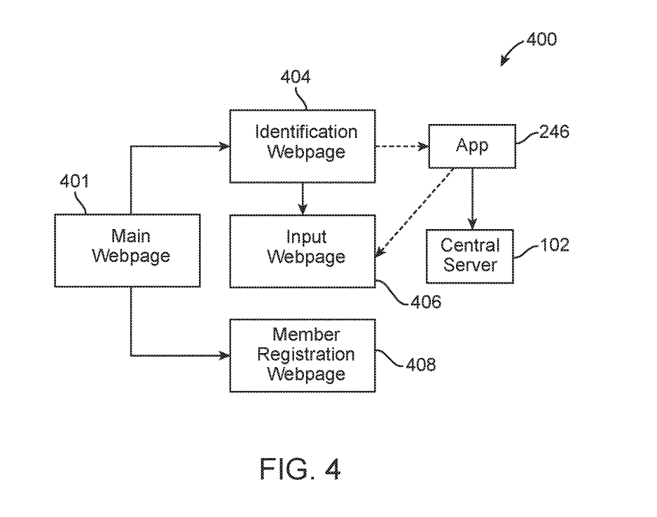

Referring to FIGS. 1 and 4, central server 102 includes database 108, database management system 110, calculating device 112, and communication device 114. Using network platform 104, central server 102 transmits and receives information from devices 106. A device 106 may use a webpage or webpages that link the device to network platform 104. Alternatively, a smart device application, such as application 246, is used to enhance the member experience and to reduce the dependency on web-based platforms.

As noted above, system 100 is operated remotely by central server 102. Server 102 communicates with devices 106. Devices 106 may belong to a client, or shop owner. Alternatively, devices 106 may reside with a client representative, or a shopping platform for a virtual shop. Central server 102 communicates using network platform 104.

Database 108, in addition to the functions disclosed above, includes information related to the members listed in the hierarchy structures of business entities 122. Database 108 also stores information related to the shops. Central server 102 retrieves this information using database management program 110. Database management program 110 communicates with calculating device 112 to make use of the data from database 108 and to store results from calculating device 112.

Communication device 114 manages the communication between calculating device 112 and devices 106. Communication to devices 106 also may be provided, such as for generating or updating access codes. Communication is performed primarily using network platform 104 via webpage(s) comprising several sub-pages or screens that include, at the least, main webpage 401, information webpage 402, client identification webpage 404, input webpage 406, and member registration webpage 408, as shown in FIG. 4. An additional interface may be provided for an administrator. Main webpage 401 may be used to access the other webpages shown in FIG. 4.

Member 120 must register with system 100 to create a unique profile for use with business entities 122 using member registration page 408. This profile helps tracks appropriate upline and downline relationship for a proper determination of points for use within the system. The resulting profiles may be taken to each business entity that includes member 120. Member 120 also may import his/her system profile while making a client profile at a business entity 122. The profiles and codes facilitate the tracking of points due to purchases and activities within system 100.

The client, or member, may access the functionality of system 100 by accessing the main webpage and clicking on the link for identification page 404. Identification webpage 404 is used to grant access to input webpage 406, which will be used to input the member's purchase amount and return the result of the calculation. Identification webpage 404 provides, at a minimum, an input field for the client code and an input field for a password. These values are transferred to central server 102 for granting access to and redirecting to input webpage 406. For client convenience, identification webpage 404 also may contain a link to a “forgot my password” webpage or to the main webpage. Alternatively, these fields and links may be integrated directly on the main webpage 401. If access is granted, then input webpage 406 is displayed. If access is not granted, then an error message is displayed.

Input webpage 406 is the main communication portal between member 120, mobile device 200, application 246 and central server 102. It can be customized by the client, for instance, displaying the business name or logo, or a set/changing background color. Input fields for input webpage 406 include ones for the customer code, the original purchase value of a good or service at a business entity, and a validation button. Input webpage 406 also includes a display field for the discounted amount and a “to be paid” value. Input webpage 406 also includes a link to new member creation webpage, such as member registration webpage 408, a button for a new purchase, and a button to select the customer code type used (specific to this entity or from system 100). Additionally, it is recommended that input webpage 406 includes display fields for customer information, customer name, current cumulated purchase amount, current point X level, current point Y level, and current point Z level.

Mobile device 200, via input 204, may display a numerical keyboard, like a calculator, for directly inputting the customer code and original purchase value. This enables a direct input interface for the client when using mobile device 200.

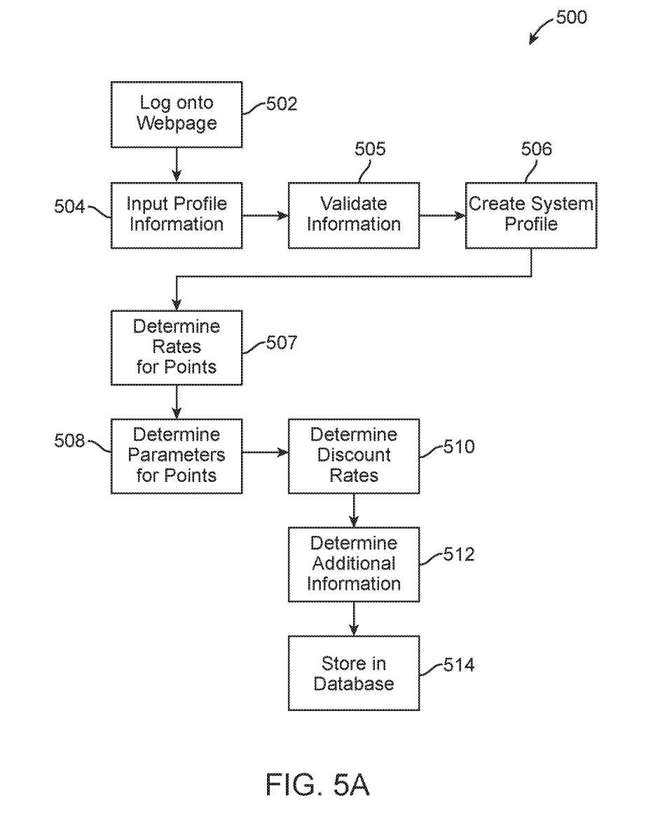

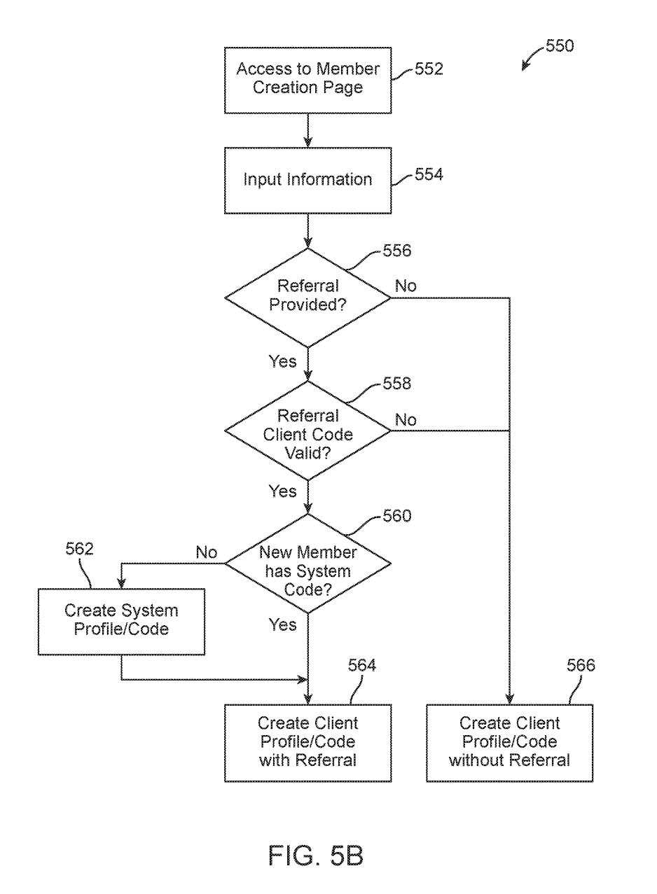

FIGS. 5A and 5B may disclose example processes for creating profiles. These processes are illustrative only, and the disclosed embodiments are not limited to these processes when creating a profile. Other processes may be used. For example, FIG. 5A depicts a flowchart 500 for registering a client profile for incorporating rewards in a hierarchy structure commerce environment according to the disclosed embodiments.

Step 502 executes by logging onto member registration webpage 408 associated with system 100. This step may be performed using mobile device 200 using an application 246 or on the page hosted by the website for system 100. Member registration webpage 408 includes input fields displayed to the member or client to receive input information. These input fields include client based code, name, surname, contact information (communication media), and the like. In addition, a validation button and a return button is displayed.

Step 504 executes by inputting profile information for a new client on the webpage. Such information includes name, optional password, a unique client code, address, email, and the like. In some embodiments, the member or client places this information into the input fields displayed on webpage 408. This information is sent to central server 102 via network platform 104.

Step 505 executes by validating the referral information for the new member. If a client based code is provided, then central server 102 accesses database 108 and checks if an entry already exists of the provide code. If a match is found, then an error message is displayed on the screen of mobile device 200.

Step 506 executes by creating the system profile for the new client. Once confirmed by central server 102, it creates the system profile for use within system 100 in accumulating and redeeming points at the business entity 122. Central server 102 generates a system code and stores it in database 108 along with the inputted profile information set forth above.

Step 507, step 508 and step 510 execute respectively by determining the rate of accumulation, parameters of reach and discount rate for each type of point X, point Y and point Z. Additionally, step 510 determines the generic discount for members and non-members.

Step 512 executes by determining any additional information or parameters for the profile. Step 514 executes by storing the generated profile along with the rates and parameters in database 108.

FIG. 5B illustrates a flowchart 550 for another process for creating a member profile according to the disclosed embodiments. Flowchart 550 may be used by system 100 to create a member profile and properly assign a member code with the appropriate referral for upline/sponsor tracking. It also ensures that proper credit is provided within business entities 122 for point tracking. The functions disclosed below may be executed on central server 120 in conjunction with devices 106.

Step 552 executes by accessing the member creation page by the new member/client to system 100. The member creation page may be similar to member registration webpage 408. Step 554 executes by inputting information for the new member. Such information may include name, optional password, address, email, and the like. This information may be stored in data storage within system 100.

Step 556 executes by determining whether a referral is provided with the input information. For business entities 122, a new member should have a referral, such as a “sponsor” or someone upline from the new member. The referral helps the new member get involved with the business and is credited with bringing the new member into each business or businesses. The referral preferably is another member and should have a code or other identification associated therewith for tracking within system 100.

Thus, if step 556 is yes, then step 558 executes by determining whether the referral client code is valid. For example, system 100 may determine whether the client code for the referral is still active. If step 558 is yes, then step 560 executes by determining whether the new member has a system code. If no, then step 562 executes by creating a system profile and code for the new member. The system profile and code may be used by the new member within system 100. If step 560 is yes, then step 564 executes by creating a member profile or code with the referral information.

If step 556 or 558 are no, then step 566 executes by creating the member profile or code without a referral. Thus, under step 566, the new member is placed within the business entity without upline. In a sense, the new member would not have his/her activities count towards a referral's point totals. The new member is not precluded from participating in system 100 or a business entity because he/she does not have a referral.

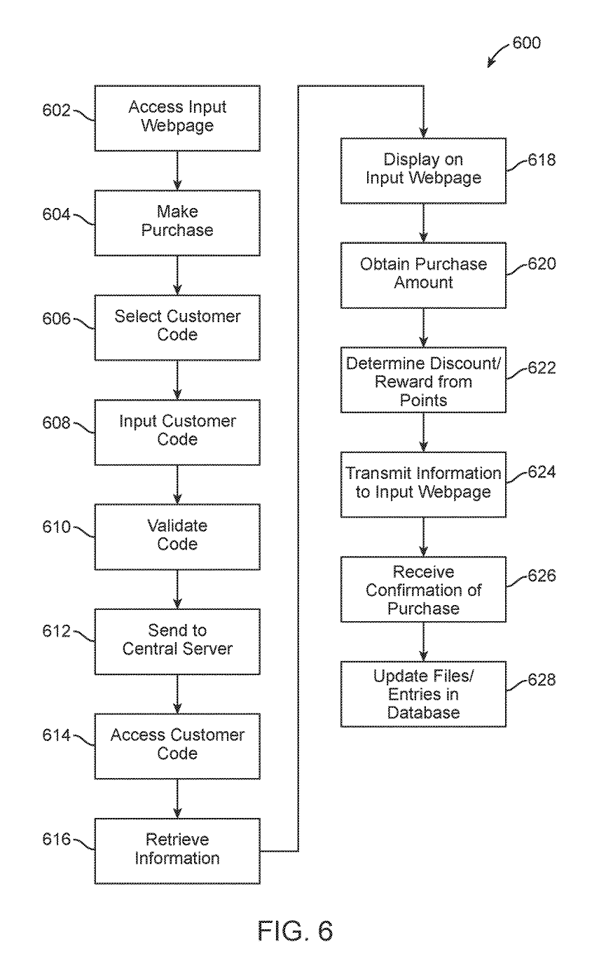

FIG. 6 depicts a flowchart 600 for making a purchase within system 100 using accumulated points according to the disclosed embodiments. FIG. 6 shows the process of a business entity 122 interacting with central server 102 via input webpage 406 during a purchase of a good or service. At the moment of a new purchase, either in a physical or virtual setting, step 602 executes by member 120 access input webpage 406 with business entity 122. If at a physical location, client or member 120 uses mobile device 200 and application 246 to display and interact with input webpage 406.

Step 604 executes by making a purchase of a good or service at a business entity 122 having a hierarchy organization, such as MLM or affiliate marketing. The purchase includes a price or cost associated with it. Step 606 executes by selecting a type of customer code used by the customer, or member, to register the purchase. The code may have been generated by the business entity or system 100. A default code value may be set in accordance with codes having the highest occurrence to help save time.

Step 608 executes by inputting the customer code via the customer code input field on input webpage 406, preferably using a displayed keypad as input 204. Step 610 executes by validating the customer code, along with any shop or business entity code and input method. Step 612 executes by sending this validation information to central server 102 via network platform 104.

Step 614 executes by central server 102 accessing database 108 to get the system customer code. This step enables central server 102 to link an existing code already used by the business entity before joining system 100. Hence, a business entity 122 may start enjoying system 100 without having to destroy a legacy system, thereby avoiding the need to generate a complete new set of codes for existing members.

Step 616 executes by retrieving information by central server 102 from database 108. When the customer code is known, central server 102 retrieves the name of the customer/member and point levels associated therewith. For example, central server 102 may retrieve current level of points X, points Y, and points Z associated to this client code, as well as the current cumulated actual purchase amount. Step 618 executes by displaying this information on input webpage 406.

In the event that the customer/member is not yet registered in system 100, central server 102 displays an error message. This action may occur when no system code is allocated. Central server 102 also may forward a link to member registration webpage 408. The input of the purchase value, however, will not be allowed.

In the event that the customer/member is already registered in system 100, but not yet with this client/business entity, central server 102 allows the input of the purchase value. The system code is recognized but there is no link created with the client code yet. Central server 102 may forward instructions to input webpage 406 to display a suggestion to the customer/member to register.

As soon as the purchase input is activated by input webpage 406, the client/business entity can key in the customer/member total original purchase amount. Thus, step 620 executes by obtaining the purchase amount of the transaction. The purchase amount can be input by direct input in the input field of input webpage 406, or via the keypad, in a similar way as for the customer code input. This value is sent to central server 102 via network platform 104 from devices 106.

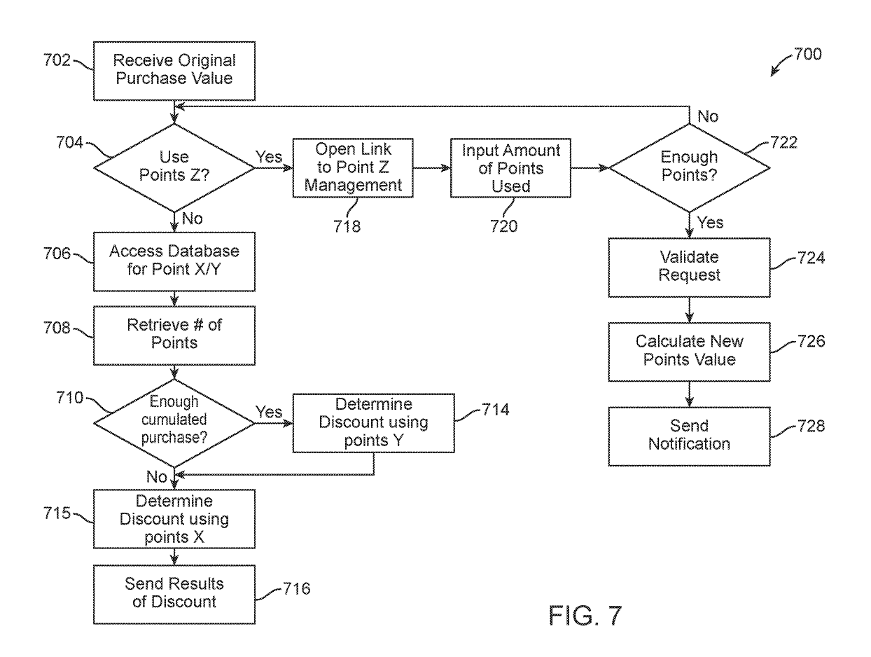

Step 622 executes by determining the applicable discount or reward based on the accumulated points and types of points associated with the customer/member. Central server 102 may perform this step, as disclosed in greater detail by FIG. 7. FIG. 7 depicts a flowchart 700 for calculating discounts and rewards for a purchase within system 100 according to the disclosed embodiments.

Step 702 executes by receiving the original purchase price from the client/business entity at central server 102. Specifically, the original purchase price may be forward to calculation device 112. As noted above, calculation device 112 may be a processor configured to be a special purpose processor by executing software instructions. The original purchase price is sent via input webpage 406.

Step 704 executes by determining whether the member plans to use points Z, related to points used at the business entity/client exchanged for free goods or services. In short, these points are used as a reward as opposed to a discount on goods or services. If no, then points X or Y will be used to provide a discount on the purchase price.

Step 706 executes if step 704 is no by accessing database 108 for the point totals of the member. As disclosed in greater below, points for activities within the different business entities 122 by the member and their marketing network accumulates points for the member to use. The points are stored in database 108 and available for use when a purchase is being made at one of the business entities. Calculation device 112 retrieves these amounts in step 708. The amounts may be sent to input page 406 for display to the member.

Step 710 determines whether the member has enough cumulated actual purchase amount. System 100 or each business entity 122 may require a certain amount of cumulated purchases prior to providing any discount to the member. If step 710 is yes, then step 714 executes by determining the discount based on the number of points Y available. Flowchart 700 proceeds to step 715.

If step 710 is no, then flowchart 700 proceeds directly to step 715. Step 715 executes by determining the discount based on the number of points X available. A limit, however, of the total discount after this step may be set, thereby limiting the usage of points X. Calculation device 112, at a minimum, determines total discount, new cumulated actual purchase value, new point X value, and new point Y value. These results are sent to input page in step 716.

If step 704 is yes, then step 718 executes by opening a link to a management feature for points Z. For example, a new webpage may be opened in addition to input webpage 406. The member or client enters the amount of points Z to redeem in the new webpage in step 720. Alternatively, the actual good or service to receive by converting the points may be entered. Input includes the amount of points Z to be deducted. The webpage includes a validation button and a return button to leave this webpage to return to input webpage 406. Preferably, the name and surname of the member as well as the system code and current point Z amount is displayed.

Step 722 determines whether enough points Z exist to redeem for the good or service at the client/business entity. Central server 102, or calculating device 112, determines if enough points Z are available for the inputted values. If no, then flowchart 700 returns to step 704 to process other types of points for possible discounts. If yes, then step 724 executes by validating the proposed reward or exchange against any policies or rules for the business entity. For example, points may be redeemed for only certain products or services.

Step 726 executes by calculating the new point value for type Z points by deducting the inputted amount from the current point Z value retrieved from database 108. Calculating device 112 assists in this process. The information in database 108 may be updated after subtracting the points used in the redemption. Step 728 executes by sending notification to the member or client/business entity, preferably to input webpage 406.

Referring back to FIG. 6, step 622 provides the discounted price or applicable reward after performing the calculation using the types of points available for the purchase. Step 624 executes by transmitting the discount and other information to input webpage 406. The other information includes the actual purchase value, total discount as applied by redeeming all points, point X value, point Z value at this business entity, and, if applicable, point Y value at this business entity.

Step 626 executes by receiving confirmation of the purchase with the discount via input webpage 406. Step 628 executes by updating files/entries in database 108 with the transaction. Central server 102 records the details of the transaction, for later analysis, by adding a line in a transaction log stored in database 108.

As can be appreciated, the calculation of the increment amounts of points X, Y, and Z is very important. The calculation should occur periodically, and can be set by system 100 or each business entity 122. For example, points can be accumulated and totaled every hour, day, week, every Monday, the first business day of the month, the last day of the month, and the like. All of a member's activities of a given client may be considered simultaneously. Alternatively, the summary of activities for the different business entities may occur at different time. The results of point accumulation are sent to central server 102.

For example, the disclosed embodiments may have the activity of business entity A members calculated every Monday at 3 pm, while the activity of business entity B is calculated on the 1^{st} of each month at 1 am. Different calculation periods may be advisable to stagger the load on central server 102 receiving updates and calculating device 112 performing operations to update records stored in database 108. The staggered load avoids the probability of high traffic problems, reduces the calculation load at each calculation, results in faster output and reduced risk to impact response speed when a client accesses system 100, and the like, as well as providing frequent increase information of points X for member having linked members active in several business entities 122.

For a given client/business entity, central server 102 accesses the part of database 108 associated with the client/business entity code to retrieve the members' accumulated actual purchase amounts. Central server 102 may proceed by hierarchy, or from the highest member(s) in the hierarchy, down to the lowest, to determine the purchases at the entity. Alternatively, it may perform member code sorting from the smallest, or earliest, member code to the largest, or any systematic method that makes sure all members within the business entity and their activities are accounted for. Central server 102, in conjunction with calculating device 112, also makes sure that there is no redundancy in the point determinations. Central server 102 also retrieves the basic calculation rules for the business entity, such as the commission rates for points X, Y, and Z, and the amount of sub-generation levels for compensation.

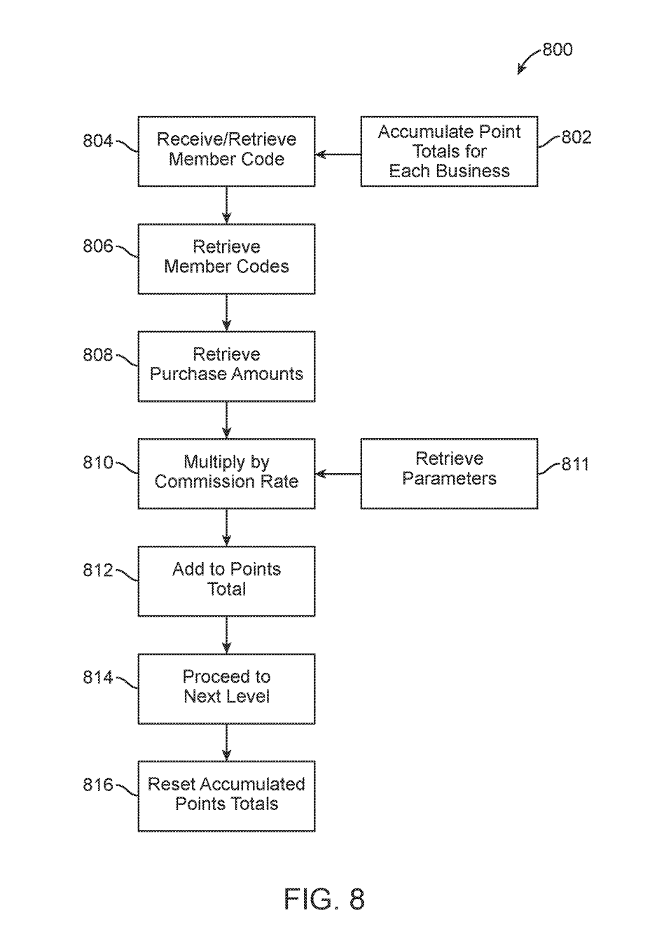

To emphasize these features, FIG. 8 depicts a flowchart 800 for accumulating point totals for a member 120 within a business entity 122 according to the disclosed embodiments. The disclosed process in flowchart 800 may occur for each member 120 within a business entity 122. The process also can occur whenever specified as noted above. As disclosed below, flowchart 800 refers to a single member of the group of members within the hierarchy of the business organization.

Step 802 executes by accumulating point totals for each business entity 122, at the times specified. The accumulated points may be stored at the business entity or forwarded to central server 102. Step 804 executes by receiving or retrieving the member code for member 120. Central server 102 includes instructions for each member when doing the updates for point totals at that time.

Step 806 executes by retrieving the member codes of members directly linked to the member code of member 120. Central server 102 retrieves these codes from database 108. Step 808 executes by retrieving the cumulated actual purchase amounts associated with these members for this client/business entity. Other activities that accumulate points also may be retrieved. Central server 102 can log onto a database at business entity 122 or access records stored in database 108.

Step 810 executes by multiplying the cumulated actual purchase amount for each member with the commission rates for the different types of points. Each type of point may have a different commission rate. For example, type X points may be 25% of the purchase amount, type Y points may be 10%, and type Z points may be 15%. The different commission rates reflect the importance of the points to the respective business entity. A business entity may reward more for activities and purchases done at the entity itself. Step 812 executes by adding the different types of points calculated to the existing point totals. These steps may occur for the first level of downline connected members of member 120.

Step 814 executes by proceeding to the next level within member 120's hierarchy to perform steps 804-812 again for these members connected to member 120. In other words, these may be members connected to member 120 through the first level of downline members. The point totals for the second level is added to the different categories of points for member 120. The process is repeated to cover as many levels as allowed, or until the totality of members connected to member 120 is reached.

The process of flowchart 800 is repeated until every member is analyzed and goes through the point total steps with an update to their points for categories X, Y, and Z. Step 816 executes by resetting the actual cumulated purchase amounts to 0 (zero) in the business entity for all members listed in this business entity. Through this process, all points are provided to the members within the business entity and proper credit given to the upline members.

System 100, therefore, enables the disclosed processes for point accumulation to encompass several business entities 122. This is done by allocating independently a set of parameters that are used for the calculations. The parameters may be the same for all entities, but their respective value may be set differently for each entity. Thus, step 811 executes in flowchart 800 by retrieving parameters for commissions set in flowchart 500. These parameters, which are specific to the business entity, are used to determine the commissions for each category of points as well as the limits on members tied to member 120 that provide points for their activities.

For each member 120 in system 100, there are two levels of profile, entity-wide and system-wide. A member has the possibility to make an entry in system 100 by either through an entity, or directly to system 100. Preferably, a member makes the entry to system 100 through a business entity 122. Member 120, however, must have a system-wide profile. It is not necessary to have an entity-wide profile for each entity 122 within system 100, though this may occur upon registration with one business entity. The entity-wide profile may be submitted to the other business entities 122.

System wide parameters include a unique identification number and the type X points. In addition, the parameters may include other information for identification, such as name and surname, and communication media, such as phone number, email or social media support. Entity-wide parameters may include the cumulated actual purchase amount, the type Z points, the type Y points, and the direct downline members' identification as listed in the specific entity. These profiles are stored and maintained in database 108 at central server 102.

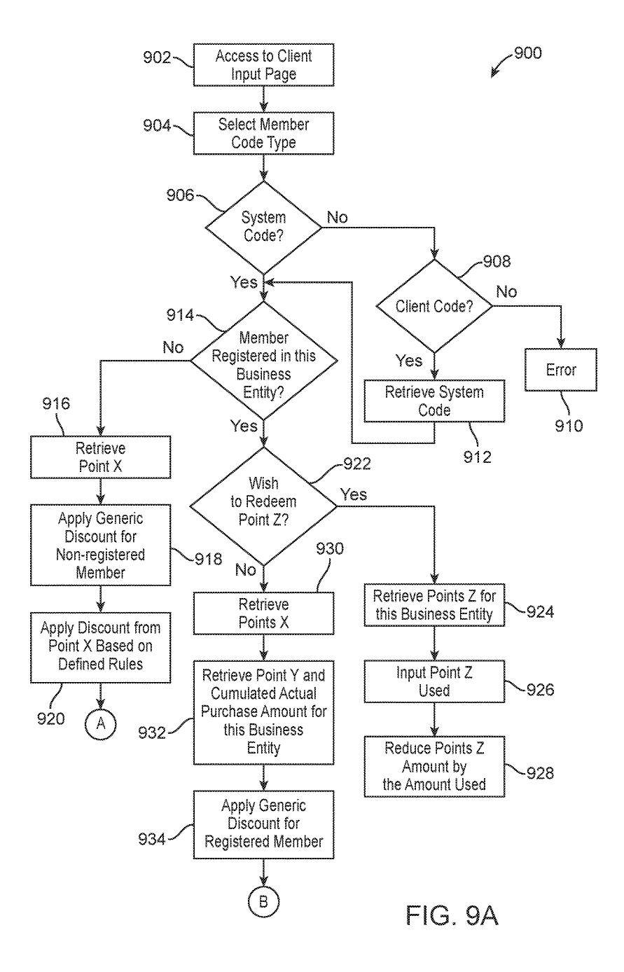

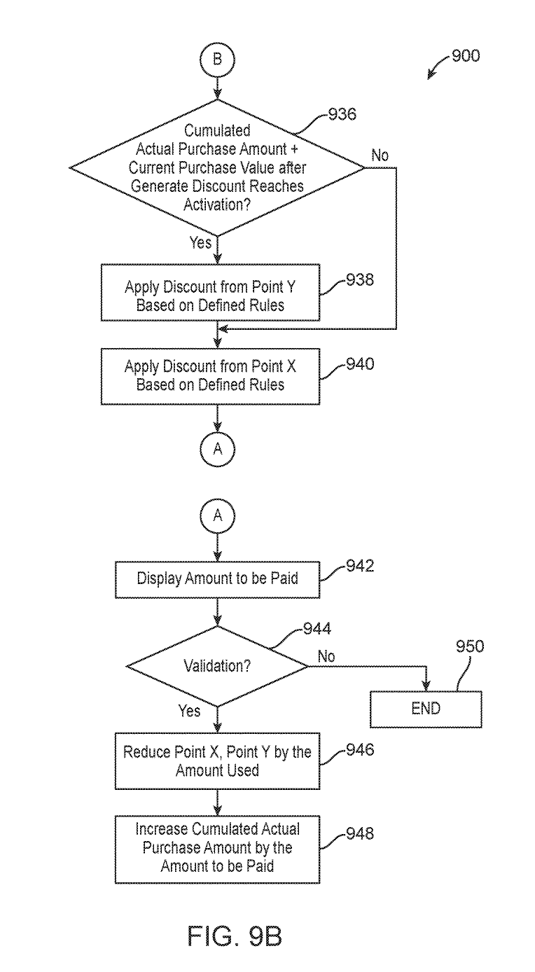

FIGS. 9A and 9B depict a flowchart 900 for using points within system 100 according to the disclosed embodiments. Flowchart 900 may complement the embodiments disclosed above, or may provide a stand-alone process for redeeming points by member 120. The functions of flowchart 900 may be set as program instructions stored on central server 102 and used to convert central server 102 into a special purpose computer to redeem the points using the disclosed process. Further, the retrieving steps disclosed below involved a device 106 accessing a storage location within database 108 to transmit the desired information to device 106 to complete the transaction.

Step 902 executes by accessing the client input page. Access may occur when member 120 is going to make a purchase at a business entity 122. Step 904 executes by selecting a member code type. Step 906 executes by determining whether a system code exists for member 120. The system code allows the points for the member throughout system 100 to be accounted for.

If step 906 is no, then step 908 executes by determining whether a client code exists for member 120 at the business in which the purchase is being made. As mentioned earlier, a client code should be generated for members when they register with system 100 or at a business entity 122. If no, then step 910 executes by showing an error with the transaction. If step 908 is yes, then step 912 executes by retrieving the system code for member 120. Flowchart 900 then proceeds to step 914.

If step 906 is yes, then step 914 executes by determining whether member 120 is registered with this business entity 122. If no, then step 916 executes by retrieving points X. Step 918 executes by applying a generic discount for a non-registered member of business entity 122. Step 920 executes by applying the discount from points X based on the defined rules for redeeming points at business entity 122. Flowchart 900 then proceeds to step 942.

If step 914 is yes, then step 922 executes by determining whether member 120 wishes to redeem points Z for goods or services at business entity 122. If yes, then step 924 executes by retrieving points Z for this business entity 122. Step 926 executes by inputting points Z used for this transaction. Step 928 executes by reducing the amount of points Z by the amount used for the transaction.

If step 922 is no, then step 930 executes by retrieving points X. Step 932 executes by retrieving points Y and the cumulated actual purchase amount for this business entity 122. Step 934 executes by applying the generic discount for a registered member within this business entity 122. Flowchart 900 then proceeds to step 936.

Step 936 executes by determining whether the cumulated actual purchase amount and the current purchase value after the generic discount reaches an activation level. The use of the activation level is disclosed above. For certain types of points, member 120 needs to reach the activation level in order to redeem them. If yes, then step 938 executes by applying the discount from points Y based on the defined rules. If step 936 is no or following step 938, then step 940 executes by applying the discount from points X based on the defined rules. Flowchart 900 then proceeds to step 942.

Step 942 executes by displaying the amount to be paid after accounting for all applicable discounts. Because of the involvement of member 120 in system 100, the purchase price should be reduced. Step 944 executes by determining a validation status of the transaction and use of the points. If yes, then step 946 executes by reducing points X and Y by the amount used in the transaction. Step 948 executes by increasing the cumulated actual purchase amount to the amount to be paid in the transaction. In other words, system 100 ensures that member 120 gets credit for the transaction. If step 944 is no, then step 950 executes by ending the process disclosed by flowchart 900.

The disclosed embodiments of FIGS. 9A and 9B may be shown by the following examples. The examples are for illustrative purposes, and the disclosed embodiments may deviate from the examples as long as the deviations are within the scope of the claims.

A case may arise where a member 120 is registered in system 100, but not listed in the business entity 122 at which he/she intends to make a purchase or redeem points. In such a case, member 120 may receive, at first, a generic discount as a percentage of the original purchase value, as defined by the policy of business entity 122. After this, member 120 may receive an additional discount from the conversion of type X points. This conversion may occur at a rate defined in the entity policy, limited to a percentage (less or equal to 100% but more than 0%) of the available points, and to a maximum overall discount as a percentage of the original purchase value. The transaction is then recorded in system 100 upon validation/confirmation, as disclosed above. This relationship may be expressed as the minimum, or MIN, of [maximum discount rate for point X usage for non-registered members*original purchase value−generic discount; rate of usage of point X for non-registered members*amount of points X].

### Example 1

Member 120 makes a purchase of $100 at business entity or shop A.

Shop A's generic discount for non-registered members—3%.

Maximum discount with use of type X points for non-registered members—30%.

Rate of usage of points X for non-registered members—20%.

Current points X for member 120—150 points.

Generic discount in business entity A—3%*$100=$3.

Points X used—Min [30%*$100−$3; 20%*150 points]=Min [$27:$30]=27.

Overall discount—$3+$27=$30.

Actual purchase value to member 120—$70.

### Example 2

Member 120 makes a purchase of $100 at business entity A.

Shop A's generic discount for non-registered members—3%.

Maximum discount with use of type X points for non-registered members—30%.

Rate of usage of points X for non-registered members—20%.

Current points X for member 120—50 points.

Generic discount in business entity A—3%*$100=$3.

Points X used—Min [30%*$100−$3; 20%*50 points]=Min [$27:$10]=10.

Overall discount—$3+$10=$13.

Actual purchase value to member 120—$87.

Thus, as can be seen, points within system 100 help reduce the costs of items sold across business entities within system 100.

A member 120 registered may practice the disclosed embodiments in system 100 and be listed in business entity 122 at which he/she intends to make a purchase, whether or not listed in another business entity. In this situation, member 120 is entitled to all types of discounts by following the disclosed processes. Similar to examples 1 and 2, member 120 receives a generic discount, as a percentage of the original purchase value, as defined in the entity policy. The percentage of the generic discount may be different from the previous cases, preferably at a level same or higher than the discount for non-registered members.

Should member 120 achieve the defined activation level set forth in the policy, he/she is entitled to additional discounts based on the conversion of type Y points. The conversion occurs at a rate defined in the entity policy and is limited to the amount of available points as well as the amount of the purchase value subject to the redemption of points Y. To assess the amount of the purchase value subject to the redemption of points Y, system 100 with central server 102 and calculating device 112 calculates the sum of the historical actual purchase value, or what has actually been paid by member 120 at business entity 122, within this calculation period or retrieves the cumulated actual purchase amount from database 108, plus the current purchase value after the generic discount, minus the activation level.

If the result of this calculation is negative, then member 120 has not reached the activation level yet. The amount of the purchase value subject to the redemption of points Y is zero (0). If the result of this calculation is less than the current purchase value after discount, then member 120 has reached the activation level due to the current purchase so only the amount exceeding the activation level will be used. The amount of the purchase value subject to the redemption of points Y is the result of this calculation.

If the result of this calculation is greater than or equal to the current purchased value, then the activation level has been reached previously. The totality of the purchase value after the generic discount may be used. The amount of the purchase value subject to the redemption of points Y is the purchase value after the generic discount. One way to express this relationship is, for points Y used, MIN [current purchase value after generic discount, points Y available, MAX (cumulated actual purchase value+current purchase value after generic discount−activation level, 0)].

An additional discount may be granted by converting points X, in a similar way as shown in Examples 1 and 2. The maximum discount, however, for points X may be different, or preferably higher than the discount available for a non-registered member. One way to express this relationship is, for points X used, MIN [MAX (1−maximum discount rate for point Z usage for a registered member)*original purchase value−generic discount−points Y used, 0], original purchase value−generic discount−points Y used, rate of usage of points X for a registered member*points X]. These transactions may be recorded by system 100 upon validation/confirmation.

The disclosed embodiments may be shown by the following examples. The examples are for illustrative purposes, and the disclosed embodiments may deviate from the examples as long as the deviations are within the scope of the claims.

### Example 3

Member 120 makes a purchase of $100 at business entity B.

Generic discount for registered members—5%.

Maximum discount with points X for registered members—50%.

Rate of usage of points X for registered members—30%.

Activation level—200 points.

Member 120 current points Y—200.

Member 120 current points X—300.

Member cumulated actual purchase amount—$0.

Generic discount—5%*$100=$5.

Point Y usage—MIN [$100-$5, 200, MAX ($0+($100−$5)−200, 0)]=MIN [$95, 200, 0]=0.

Point X usage—MIN [MAX [(1−50%)*$100−$5−0, 0], $100−$5−0, 30%*200]=MIN [MAX [45, 0], $95, 60]=MIN [45, 95, 60]=45.

Actual purchase amount—$100−$5−$0−$45=$50.

### Example 4

Member 120 makes a purchase of $100 at business entity B.

Generic discount for registered members—5%.

Maximum discount with points X for registered members—50%.

Rate of usage of points X for registered members—30%.

Activation level—200 points.

Member 120 current points X—200.

Member 120 current points Z—300.

Member cumulated actual purchase amount—$120.

Generic discount—5%*$100=$5.

Point Y usage—MIN [$100−$5, 200, MAX ($120+($100−$5)−200), 0)]=MIN [$95, 200, 15]=$15.

Point X usage—MIN [MAX [(1−50%)*$100−$5−15, 0], $100−$5−15, 30%*200]=MIN [MAX [30, 0], $80, 60]=MIN [30, $80, 60]=$30.

Actual purchase amount—$100-$5-$15-$30=$50.

### Example 5

Member 120 makes a purchase of $100 at business entity B.

Generic discount for registered members—5%.

Maximum discount with points X for registered members—50%.

Rate of usage of points X for registered members—30%.

Activation level—200 points.

Member 120 current points Y—200.

Member 120 current points X—300.

Member cumulated actual purchase amount—$300.

Generic discount—5%*$100=$5.

Point Y usage—MIN [$100−$5, 200, MAX ($300+($100−$5)−200),0)]=MIN [$95, 200, 195]=$95.

Point X usage—MIN [MAX [(1−50%)*$100−$5−95, 0], $100−$5−95, 30%*200]=MIN [MAX [−50,0], $0, 60]=MIN [30, $0, 60]=$0.

Actual purchase amount—$100−$5−$95−$0=$0.

It may be noted that the calculation of the examples 1 and 2 expressed above may be seen as a particular situation of examples 3-5.

As disclosed above, type Z points may be converted to rewards, prizes, gifts, vouchers, and the like, or any other reward not covered above. In other words, points Z are not used for real time discounts. These points, therefore, are expected to be used separately from making a purchase.

Moreover, as the locations of the business entities are known, it is possible to define the geographic reach of member 120. Looking at business entities 122 where member 120 is listed and where he/she is active (or reaching activation levels), system 100 may determine an area of reach defined by the location of the entities, plus some set distance around it. Any other participating entity 122 located within this area theoretically is reachable by member 120, and, therefore, of potential interest. System 100 then may make targeted advertisements of the local entities 122 to member 120.

Likewise, system 100 can identify the other members already linked to member 120 within one entity 122, but missing in other entities when member 120 is already listed. System 100 may suggest to member 120 to invite the other members to the other entities. As for virtual entities, such as e-commerce businesses, system 100 also may suggest new entities or suggest invitations to other members based on the entities where they are active, and the type of product that interest these members. These features bring the further advantage to the participating entities 122 to be part of system 100.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A computer-implemented method for using discount based incentives in a marketing environment having a plurality of business entities connected by a network, wherein the plurality of business entities include members linked in a hierarchical structure, the method comprising:
accumulating a first type of points based on activity within a first business entity by a member and at least one downline member associated with the member within the first business entity and based on activity within a second business entity by the member and at least one downline member associated with the member within the second business entity;
accumulating a second type of points based on activity within the first business entity by the member and at least one downline member associated with the member within the first business entity;
storing the first type of points and the second type of points in a database connected to the first and second business entities;
accessing a client input page on a device connected to the network by the member to make a purchase at the first business entity;
retrieving an amount of the first type of points and an amount of the second type of points from the database in response to accessing the client input page;
redeeming an amount of the first type of points and an amount of the second type of points according to the first business entity; and
applying a discount to the purchase by the member based on the amount of the first type of points and the amount for the second type of points at the first business entity.

2. The computer-implemented method of claim 1, further comprising applying a generic discount for the member as determined by the first business entity along with the discount.

3. The computer-implemented method of claim 1, further comprising accumulating a third type of points based on activity of the member and the at least one downline member within the first business entity, wherein the third type of points relate to an exchange or voucher for use within the first business entity.

4. The computer-implemented method of claim 3, further comprising redeeming the third type of points for the exchange or voucher.

5. The computer-implemented method of claim 3, further comprising determining whether to retrieve the third type of points for redemption at the first business entity.

6. The computer-implemented method of claim 1, further comprising determining whether the member has reached an activation level with regard to the second type of points accumulated at the first business entity.

7. The computer-implemented method of claim 6, further comprising allowing the redemption of the second type of points based on the activation level.

8. The computer-implemented method of claim 1, wherein the at least one downline member of the first business entity differs from the at least one downline member of the second business entity.

9. A computer-implemented method for applying a discount within a marketing environment having a plurality of business entities associated with each other over a network connected to a central server, wherein the plurality of business entities include members linked in a hierarchical structure, the method comprising:
accessing a page on a device connected to the network to make a purchase at a first business entity;
retrieving, from the central server, a first type of points for a member of the plurality of business entities, wherein the first type of points is related to the first business entity and to a second business entity from the central server;
retrieving, from the central server, a second type of points for the member, wherein the second type of points is related to the first business entity that is separate from the second business entity;
determining whether to redeem the first type of points and the second type of points in conjunction with making the purchase at the first business entity; and
applying a discount based on the redemption of the first type of points and the second type of points to the purchase.

10. The computer-implemented method of claim 9, wherein the first type of points are related to activity by the member and at least one downline member at the first business entity and to activity by the member and at least one downline member at the second business entity.

11. The computer-implemented method of claim 9, wherein the second type of points are related to activity by the member and at least one downline member at the first business entity.

12. The computer-implemented method of claim 9, further comprising retrieving a third type of points based on activity of the member and the at least one downline member within the first business entity; and
redeeming the third type of points for an exchange or voucher for use within the first business entity.

13. The computer-implemented method of claim 9, further comprising determining whether the member has reached an activation level with regard to the second type of points related to the first business entity.

14. The computer-implemented method of claim 13, further comprising not allowing use of the second type of points for the discount if the activation level has not been reached.

15. The computer-implemented method of claim 9, further comprising applying a generic discount based on the first business entity.

16. A computer network system comprising:
a plurality of business entities connected over a network to a central server, wherein each of the plurality of business entities includes a hierarchical member structure such that each member within each of the business entities are linked together;
the central server having a database to store information about each of the plurality of business entities;
a communication device at the central server to exchange data between the central server and a plurality of devices associated with each member with each of the business entities; and
a calculation device at the central server to determine a discount for a purchase within a first business entity based on a second type of points accumulated from activity of a member and at least one downline member with the first business entity and further based on a first type of points accumulated from activity of the member and at least one downline member with the first business entity and from activity of the member and at least one downline member within a second business entity separate from the first business entity.

17. The computer network system of claim 16, further comprising a database management system for the database, wherein the database management system retrieves information for the first type of points and the second type of points.

18. The computer network system of claim 16, wherein each of the plurality of business entities include a multi-level marketing business structure.

19. The computer network system of claim 16, wherein the calculation device determines a third type of points related to activity of the member and at least one downline member within the first business entity to redeem for an exchange or voucher at the first business entity.
